(19) United States
(12) Patent Application Publication
(10) Pub. No.: US 2024/0174304 A1
(43) Pub. Date: May 30, 2024

(54) INTEGRATED CAB DESIGN FOR A SEMI-TRUCK VEHICLE

(71) Applicant: HYZON MOTORS USA INC., Bolingbrook, IL (US)

(72) Inventors: Wei Fan, Shanghai (CN); Dong Shi, Shanghai (CN); Xu Gao, Suzhou City (CN); Qunlong Dong, Ellicott City, MD (US)

(21) Appl. No.: 18/525,510

(22) Filed: Nov. 30, 2023

Related U.S. Application Data
(60) Provisional application No. 63/428,987, filed on Nov. 30, 2022.

(51) Int. Cl. B62D 33/06; B60J 1/00; B60K 15/067

(52) U.S. Cl. CPC B62D 33/06; B60J 1/008; B60K 15/067; B60K 2015/0637

(57) ABSTRACT

A cab for a semi-truck vehicle may include a main body with a wrap around windshield providing a predetermined field of front vision and side vision. The cab may further include a seat, a rear wall, and a cabin interior accommodating a driver. The cabin interior may be located between the wrap around windshield and the rear wall and include a frontside volume and a rearside volume. A doorway formed in the main body may provide ingress to and egress from the cabin interior. A plurality of front entry steps may be disposed beneath the doorway. A door may be configured to selectively open and close the doorway, allowing direct access to the frontside volume of the cabin interior. The cab design may optimize visibility, accessibility, and interior space utilization for the driver.

### CROSS-REFERENCE TO RELATED APPLICATIONS

This application claims the benefit of U.S. Provisional Application No. 63/428,987, filed on Nov. 30, 2022. The entire disclosure of the above application is incorporated herein by reference.

### FIELD

The present technology includes articles of manufacture and processes that relate to a semi-truck, including devices, systems, and methods for a semi-truck having improved sight lines, improved ride quality, and which provides improved ingress and egress to and from a cab of the semi-truck.

### INTRODUCTION

This section provides background information related to the present disclosure which is not necessarily prior art.

Fuel cell applications have potential to drive the future of mobility. Regions such as the U.S., China, Europe, and Japan, among others are recognizing this trend and focusing policy efforts on developing fuel cell technology, supply chain, and infrastructure on multiple fronts. Fuel cells for transportation may include a wide range of use cases. Findings suggest that fuel cell technologies may be ideal for a decarbonization of heavy duty and/or long-range transport applications. These segments may include heavy-duty trucks, large passenger vehicles with long-ranges, and long-distance coaches. Studies of fuel cell powered trucks suggest that this technology may be a low cost way to decarbonize both the medium-duty and the heavy-duty segments.

Fuel cell powered trucks may use the same basic electric drivetrain as battery powered trucks (and may even include a battery), but due to their on-board fuel storage, fuel cell trucks can have a much longer range, require fewer stops on long routes, can be fueled much faster, and can better match the traditional cargo capacity of internal combustion powered trucks. The unique features of a fuel tank assembly and the location of the fuel cell tank assembly on a semi-truck allow certain interior and exterior features of the semi-truck to be improved.

In particular, it is important that a semi-truck includes proper sight lines, ergonomically correct seats, and the ability to comfortably climb into and climb out of the semi-truck because a driver may spend long hours in the semi-truck and discomfort and/or improper sight lines over long periods of time may be undesirable.

Previous approaches to designing cabs for semi-truck vehicles have focused on providing a comfortable and functional space for the driver while ensuring optimal visibility and safety. These approaches have typically involved incorporating a windshield at the front of the cab to provide a clear view of the road. However, these windshields have been limited in their coverage, often extending only across the front of the cab and thus providing limited side vision.

In addition to the windshield, previous designs may have included a main body that encompasses a driver's seating area and provides structural support for the cab. The main body has typically been rectangular in shape, with a forward side and a rearward side located at opposite ends of the length of the cab. The main body may have also featured a wheel well to accommodate the vehicle's wheels and contribute to an overall stability of the cab.

To facilitate entry and exit from the cab, previous designs may have incorporated a doorway with defined edges, including a front edge, a rear edge, a top edge, and a bottom edge. The doorway may provide an access to the interior of the cab, allowing the driver to enter and exit a seating area. However, the positioning and dimensions of the doorway may vary in design and impact an ease of ingress and egress of the driver.

Furthermore, previous designs may include a rear wall located behind the driver's seating area. This rear wall may serve as a barrier between the seating area and a rear portion of the cab and provide structural support to define boundaries of the cabin interior. The positioning of the rear wall in relation to the seating area may vary and affect the available space and layout within the cab.

In particular, previous approaches to designing cabs for semi-truck vehicles have focused on incorporating windshields for visibility, defining the main body structure, providing doorways for entry and exit, and incorporating a rear wall for cabin separation. However, none of these approaches have provided a comprehensive solution that combines the features described in this disclosure.

Accordingly, there is a need for a fuel cell powered semi-truck design which provides improved sight lines, an improved ride quality, and which provides improved ingress and egress to and from a cab of the semi-truck.

### SUMMARY

In concordance with the instant disclosure, a semi-truck design which provides improved sight lines, an improved ride quality, and which provides improved ingress and egress to and from a cab of the semi-truck, has been surprisingly discovered.

In certain embodiments, the techniques described herein may relate to a cab for a semi-truck vehicle, including: a main body having a forward side, a rearward side, a first side, a second side, a length, a wraparound windshield, and a wheel well. The forward side and the rearward side of the cab may be located at opposed ends of a length of the main cab body, and the wrap around windshield may be disposed across an entirety of the forward side and across only part of the first side and the second side. The wrap around windshield may have a rear end on each of the first side and the second side, the wrap around windshield further having a predetermined field of front vision, a predetermined field of side vision, and a predetermined shield angle.

The wheel well may include a front portion and a rear portion. A seat disposed within the main body may have a frontside and a rearside. A rear wall may be disposed within the main body and behind the rearside of the seat. The rear wall may be spaced apart from the rearward side of the main body and a cabin interior may be configured to accommodate a driver. The cabin interior may be located within the main body between the wrap around windshield and the rear wall, where the seat is disposed within the cabin interior. The cabin interior may further include a frontside volume and a rearside volume, where the frontside volume may be disposed between the seat and the wrap around windshield, and the rearside volume may be disposed between the seat and the rear wall. A doorway may be further formed in the main body.

The doorway may have a front edge, a rear edge, a top edge, and a bottom edge. The doorway may provide an ingress and egress to the cabin interior. A plurality of front entry steps may provide an ingress to and an egress to the cabin interior. The plurality of front steps may be disposed beneath the doorway and adjacent to the rear portion of the wheel well. The door may be configured for selectively opening the doorway in an opened position and selectively closing the doorway in a closed position, The door may be disposed adjacent the front portion of the wheel well of the main body to permit ingress and egress directly to the frontside volume of the cabin interior by the driver using the front entry steps upon the door being in the opened position,

In certain embodiments, at least a portion of the seat may be disposed rearward of the rear edge of the doorway, wherein the front edge of the doorway may be disposed on a front doorway axis, where the rear edge of the doorway may be disposed on a rear doorway axis, the top edge of the doorway disposed on a top doorway axis, the bottom edge of the doorway disposed on a bottom doorway axis, the front portion of the wheel well disposed on a front wheel well axis, the rear portion of the wheel well is disposed on a rear wheel well axis, the frontside of the seat disposed on a frontside seat axis, the rearside of the seat disposed on a rearside seat axis, and the rear wall disposed on a rear wall axis. The rearside seat axis may be located forward of the rear wall axis at a predetermined distance, and the rear end of the wrap around windshield may be disposed on a rear end window axis, where the forward side of the main body may be disposed on a forward side axis, and the rearward side of the main body may be disposed on a rearward side axis.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a semi-truck body, in accordance with the present technology;

FIG. 2 is a right side elevational view the semi-truck body shown in FIG. 1;

FIG. 3 is a front side elevational view thereof;

FIG. 4 is a left side elevational view thereof;

FIG. 5 is a right side elevational view thereof;

FIG. 6 is a right side elevational view thereof showing the angles out of the wrap around window of the cab;

FIG. 7 is a front side elevational view thereof showing the side angles out of the wrap around window of the cab;

FIG. 8 is a right side elevational view thereof showing the angles of the cab;

FIGS. 9 is a side elevational view showing axis of the semi-truck, in accordance with the present technology;

FIG. 10 is a side elevational view showing certain axis of the semi-truck, in accordance with the present technology;

FIGS. 11-13 are side elevational views of the semi-truck, in accordance with the present technology;

FIG. 14A-14C are side perspective views of the semi-truck showing a stepwise sequence of an occupant climbing into the semi-truck cab, in accordance with the present technology;

FIG. 15 is a top perspective view of a frame of the semi-truck showing an embodiment of a chassis layout of the semi-truck, in accordance with the present technology; and

FIGS. 16-17 are top plan views of a frame of the semi-truck showing other embodiments of a chassis layout of the semi-truck, according to certain embodiments of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to a design of a semi-truck. The semi-truck may include a cab body. The cab body may include an interior and a door on a side of the body. The door may be configured to provide convenient access to a seat within the interior of the cab body. The cab body may further include a wraparound windshield, a sloped roof fairing, and a front lower grille that slightly protrudes at a point where it meets the windshield. A pair of headlights may frame a front left and a front right of the grille. The door may be located such that a front bottom edge of the door is located near/at a top/frontside of a wheel well. A door handle may be at a location where it can be grasped when at a step at the side of the semi-truck body.

In certain embodiments, the cab for a semi-truck may include a cab body. The cab body may have an interior including a seat for an occupant of the semi-truck. A door on a side of the cab body may be configured to provide access to the interior and the seat within the interior of the cab body. The door may be disposed adjacent a front portion of a wheel well of the cab body. A front entry step of the cab body may provide a direct access to the seat when the door is in an open position. In certain embodiments, the seat may be located behind a wheel well of the cab body. A portion of the seat may be located behind a rear edge of the door.

In certain embodiments, the seat may be movable and/or retractable. For example, a location and/or a movement of the seat may be triggered by a presence of a key, such that the seat moves to its previous position when the key is located. Alternatively, or in conjunction, the seat may be moved by pushing a power button of the semi-truck and/or a button of the seat. In particular, the location of the seat in combination with the location of the door and a front entry step may make is easy for an occupant to enter and/or leave the interior of the cab. The seat may be located on a same plane as the door and a front entry step such that the occupant may have direct access to the seat when the occupant enters the semi-truck cab. A wraparound window of the semi-truck cab may increase an outside viewing area of the occupant when the occupant is in the seat.

In certain embodiments, the semi-truck may include separate front and rear suspension systems. For example, the front suspension system may include an independent air suspension. The front suspension of the semi-truck may enable the semi-truck cab to hold a weight of the cab. A storage rack for holding a storage tank for a fuel cell may fit within a space behind the seat. In certain embodiments, the semi-truck cab may be mounted on the same frame as the storage rack. The storage rack disposed behind the seat may be covered by a shell of the semi-truck cab so that the storage rack is not visible. In certain embodiments, a location of the storage rack behind the semi-truck cab may be in a position such that the seat may move forward and backward to accommodate the occupant of the seat.

Advantageously, the present technology provides improved sight lines, improved ride quality, and an easy ingress into and egress from a cab of the semi-truck. A position of the seat within the interior of the semi-truck cab and the front windshield may improve the sightlines of an occupant within the semi-truck cab. Additionally, the location of the front entry steps and a position of the door may improve entering and exiting of the semi-truck cab and access to and from the seat. Moreover, an independent front suspension and the rigid semi-truck cab mounted to the frame may stabilize the semi-truck cab when it is loaded and driven. As such, the present technology has many advantages.

Example embodiments of the present technology are provided with reference to the several figures enclosed herewith.

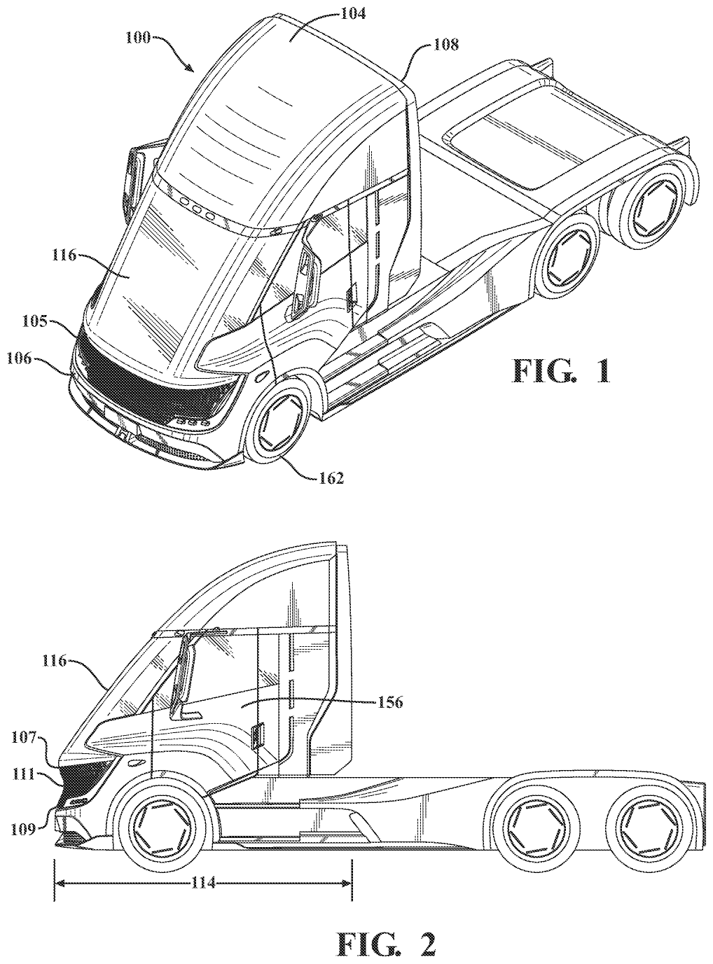

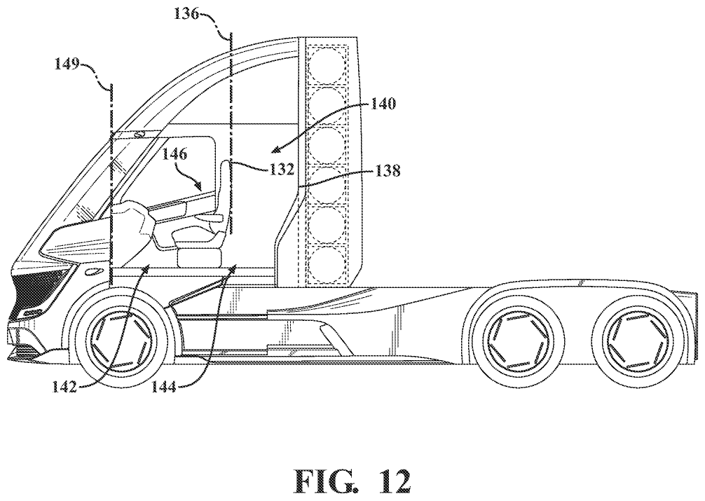

FIGS. 1-14C describe a cab 100, according to certain embodiments of the present disclosure. The cab 100 may include a main body 104 and a seat 132 disposed within the main body 104. A doorway 146 may be formed in the main body 104, and the doorway 146 may have a doorway length 147. The cab 100 may further include one or more wheels 162.

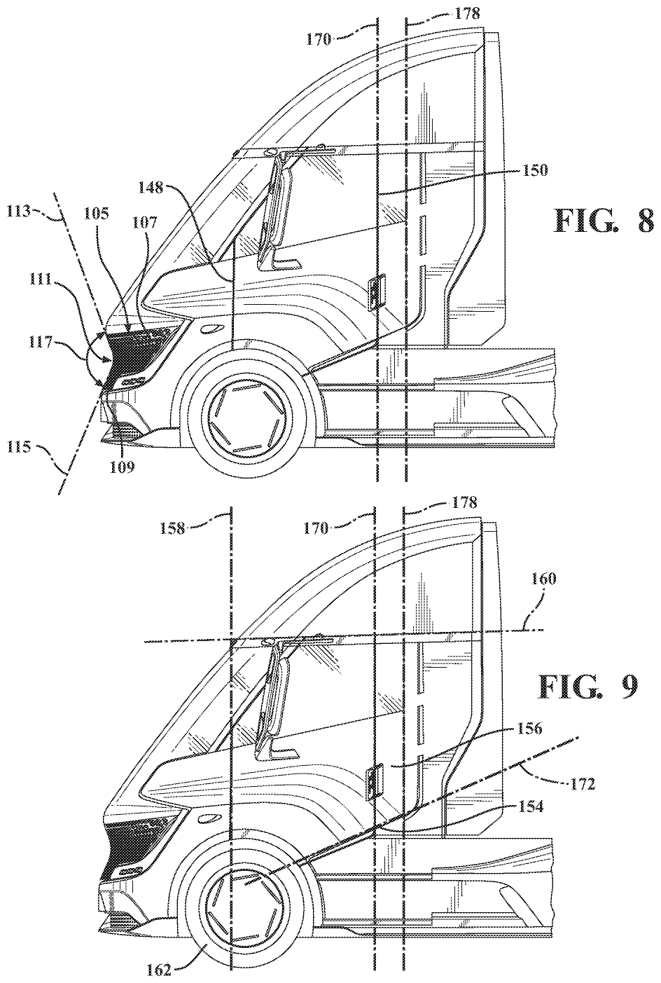

For purposes of illustrating the unique features of the cab 100 as described herein, it should be appreciated that relative locations and orientations of various features of the cab 100 may be defined by a plurality of axes as depicted in FIGS. 8-14C including, as non-limiting example, a front doorway axis 158, a rear doorway axis 170, a top doorway axis 160, a bottom doorway axis 172, a front wheel well axis 128, a rear wheel well axis 130, a frontside seat axis 164, a rearside seat axis 136, a rear wall axis 166, a rear end window axis 178, a forward side axis 168, and a rearward side axis 180. One skilled in the art can also select other suitably descriptive axes for defining relative locations and orientations of cab features, as desired.

With reference to FIGS. 11-13, The cab 100 may further include a rear wall 138 disposed within the main body 104 behind a rearside of the seat 132, such that the rear wall 138 may be spaced apart from the rearward side 108 of the main body 104. The cab 100 may also include a cabin interior 140 configured to accommodate a driver, where the cabin interior 140 may be located within the main body 104 between the wrap around windshield 116 and the rear wall 138. The seat 132 may be disposed within the cabin interior 140.

The cab 100 may also include a door 156 configured for selectively opening the doorway 146. The door 156 may permit an ingress and egress directly to the frontside volume 142 of the cabin interior 140 by the driver using the front entry steps 300 upon the door 156 when the door 156 is in the opened position. In certain embodiments, at least a portion of the seat 132 may be disposed rearward of the rear edge 150 of the doorway 146.

In certain embodiments, the main body 104 of the cab 100 may include a forward side 106, a rearward side 108, a first side 110, a second side 112, and a wheel well 125, the wheel well 125 having a wheel well length 126. The main body 104 may also include a length 114, where the forward side 106 and the rearward side 108 are located at opposed ends of a length of the main body 104. The main body 104 may also include a wrap around windshield116, the wrap around windshield 116 disposed across an entirety of the forward side 106 and across only part of the first side 110 and the second side 112.

In further embodiments, the wrap around windshield 116 may include a rear end 118 on each of the first side 110 and the second side 112. A predetermined field of front vision 120, a predetermined field of side vision 122, and a predetermined shield angle 124 of an A-pillar field of vision. In certain embodiments, the A-pillar may help determine the shape of the cab 100 and its volume. The A-pillar, its location, and its angle may define a dash to axle ratio and the shape of the cab 100 forward side 106. In particular, the A-pillar may include the structural upright that partially frames the wrap around windshield 116. In certain embodiments, A-pillars (one on each side of the body) may be joined across the top of the wrap around windshield by a header rail, wherein the base of the wrap around windshield 116 where it meets the hood is called the cowl. A portion of the roof that joins A-, B-, and C-pillars together may form the vehicle's roof structure. In certain embodiments, the seat 132 may include a frontside seat axis 164 and a rearside seat axis 136. The cabin interior 140 may include a frontside volume 142. The cabin interior 140 may also include a rearside volume 144, the frontside volume 142 disposed between the seat 132 and the wrap around windshield 116, and the rearside volume 144 disposed between the seat 132 and the rear wall 138.

In particular embodiments, the doorway 146 may include a front edge 148, a rear edge 150 of the door, and a top doorway axis 160. The doorway 146 may also include a bottom edge 154 and a front edge doorway axis 149. The doorway 146 provides ingress and egress to the cabin interior 140. The front entry steps 300 may be disposed beneath the doorway 146 and adjacent to a rear wheel well axis 130. The front entry steps 300 may be especially configured to enable a user to enter the cabin interior 140 with minimal effort. For example, the front edge 148 of the doorway 146 may be disposed on the front doorway axis 158. The rear edge of the doorway 146 may be disposed on the rear doorway axis 170. The top edge of the doorway 146 may be disposed on the top doorway axis 160. The bottom edge 154 of the doorway 146 may be disposed on the bottom doorway axis 172.

In certain embodiments, the front portion of the wheel well 125 may be disposed on the front wheel well axis 128, and the rear portion of the wheel well 125 may be disposed on the rear wheel well axis 130. The frontside of the seat 132 may be disposed on the frontside seat axis 164, and the rear side of the seat 132 may be disposed on the rearside seat axis 136, and the rear wall 138 may be disposed on the rear wall axis 166. The rearside seat axis 136 may be located forward of the rear wall axis 166 a predetermined distance 220. The rear end 118 of the wrap around windshield 116 disposed on the rear end window axis 178. The forward side 106 of the main body 104 may be disposed on the forward side axis 168. The rearward side 108 of the main body 104 may be disposed on the rearward side axis 180.

In further embodiments, the predetermined distance may be between about 260 mm and about 390 mm. In certain embodiments, the predetermined distance 220 may be about 327 mm. For example, the seat 132 may include a dorsal angle 171 of between about 14 degrees and about 20 degrees. In some embodiments, the dorsal angle 171 may be equal to or less than about 17 degrees. Without being bound to any particular theory, it is believed that this particular arrangement of the seat 132 and the rear wall axis 166 may facilitate a placement of a plurality of fuel tanks 201 for the semi-truck vehicle behind the seat 132 in a vertical arrangement where the plurality of fuel tanks 201 may be stored such that a trailer may be attached and a user may conveniently enter the cab 100 and adjust the seat 132 to an appropriately desired dorsal angle 171.

In additional embodiments, a predetermined shield angle of the A-pillar may be between about 6 degrees and about 7 degrees. For example, the predetermined shield angle of A-pillar may be about 6.3 degrees. Without being bound to any particular theory, it is believed that this particular arrangement of the predetermined shield angle may facilitate an improved field of visibility out of a front and side of the wrap around windshield 116 when a user is in the cab 100.

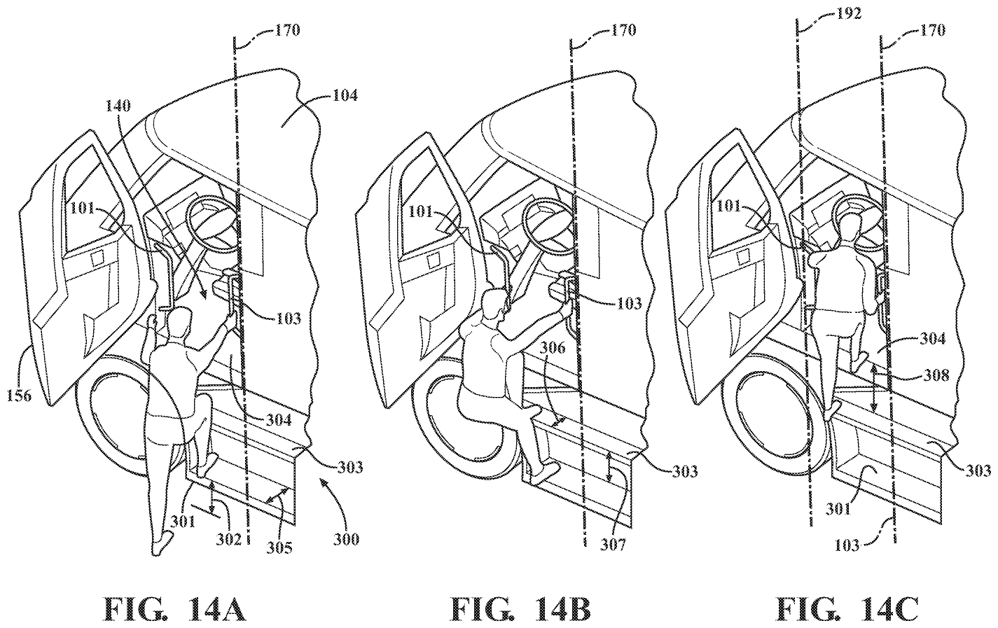

As shown in FIGS. 14A-14C, in particular embodiments the cab 100 may include a first hand hold 101 and a second hand hold 103. The first hand hold 101 may be disposed adjacent the front edge 148 of the doorway 146 and the second hand may hold disposed adjacent the rear doorway axis 170 of the doorway 146, and the first hand hold 101 and the second hand hold 103 being configured to be grabbed simultaneously by the driver while standing on the first front entry step 301 and the second front entry step 303 during ingress and egress to the cabin interior 140.

In certain embodiments, for example, as shown in FIGS. 8 and 9, the cab 100 may include a grille 105 disposed on the forward side 106 of the main body 104 under the wrap around windshield 116. The grille 105 may include a top grill section 107 and a bottom grill section 109. The grille 105 may include a concave area 111 at an intersection of the top grill section 107 and the bottom grill section 109. The grille 105 may include a top grill section axis 113, a bottom grill section axis 115, and a concave area angle 117. The top grill section 107 may be oriented on the top grill section axis 113 and the bottom grill section 109 may be oriented on the bottom grill section axis 115, and the top grill section axis 113 and the bottom grill section axis 115 may intersect to define the concave area angle 117. In certain embodiments, the concave area angle 117 may be between about 110 degrees and about 140 degrees. In certain embodiments, the concave area angle 117 may be about 125 degrees. The grille 105 may be disposed on the forward side 106 of the main body 104 under the wrap around windshield 116. The grille 105 may include a top grill section 107 and a bottom grill section 109. In certain embodiments, the wrap around windshield 116 may narrow inwardly at a location above the grille 105. The cab 100 may include the grille 105 disposed on the forward side 106 of the main body 104 under the wrap around windshield 116.

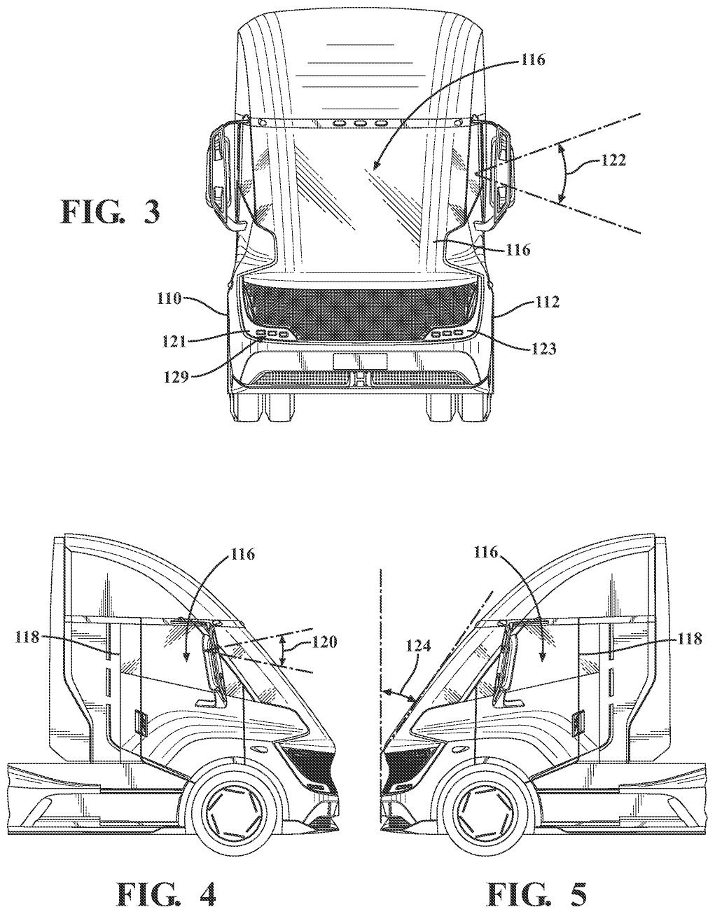

In certain embodiments, as shown in FIG. 3, for example, the cab 100 may include a first headlamp 121 and a second headlamp 123. The first headlamp 121 may be disposed adjacent to the first side 110 of the main body 104. The second headlamp 123 may be disposed adjacent to the second side 112 of the main body 104. The grille 105 may be disposed between the first headlamp 121 and the second headlamp 123. In certain embodiments, each of the first headlamp 121 and the second headlamp 123 may include a plurality of headlamp elements 129. For example, the plurality of headlamp elements 129 may be arranged in a linear series, as shown in FIG. 3. In certain embodiments, the plurality of headlamp elements 129 may be arranged linearly between the first side 110 of the main body 104 and the second side 112 of the main body 104. Other suitable arrangements of the plurality of headlamp elements 129 may also be selected within the scope of the present disclosure. In particular, without being bound to any particular theory, it is believed that this particular arrangement of the plurality of headlight elements 129 in combination with the sloped wrap around windshield 116 may enable a use to achieve better sightlines from the cab 100 when sitting in the seat 132 of the cab 100.

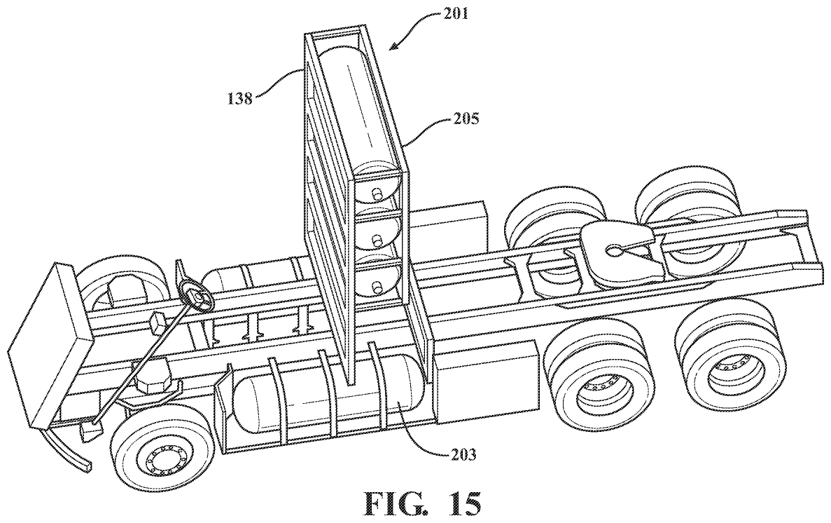

Referring now to FIGS. 15-17, the cab 100 may also include a plurality of fuel tanks 201 for the semi-truck vehicle. In certain embodiments, the frontside seat axis 164 may be disposed between the rear wheel well axis 130 and the rear doorway axis 170. The rearside seat axis 136 may be disposed between the rear doorway axis 170 and the rear wall axis 166. A bottom doorway axis 172 may be oriented at a bottom edge angle relative to a horizontal axis, the bottom edge angle being between 10 degrees and 40 degrees. The bottom edge may slope in an upward direction away from the rear wheel well axis 130 of the wheel well 125 of the main body 104. In certain embodiments, the bottom edge angle may be about 25 degrees. In certain embodiments, there may be no other door disposed reward of the door 156 of the main body 104. The rear end window axis 178 may be disposed rearward of the rear doorway axis 170. In certain embodiments, the wrap around windshield 116 may be divided by the doorway 146, with the rear doorway axis 170 being between the front doorway axis 158 and the rear end window axis 178.

In certain embodiments, the cab 100 may include a first front entry step 301, a second front entry step 303, and a third front entry step 304. The first front entry step 301 may be disposed adjacent a ground surface, the third front entry step 304 may be disposed adjacent a bottom edge 154 of the doorway 146 of the main body 104, and the second front entry step 303 may be disposed between the first front entry step 301 and the third front entry step 304.

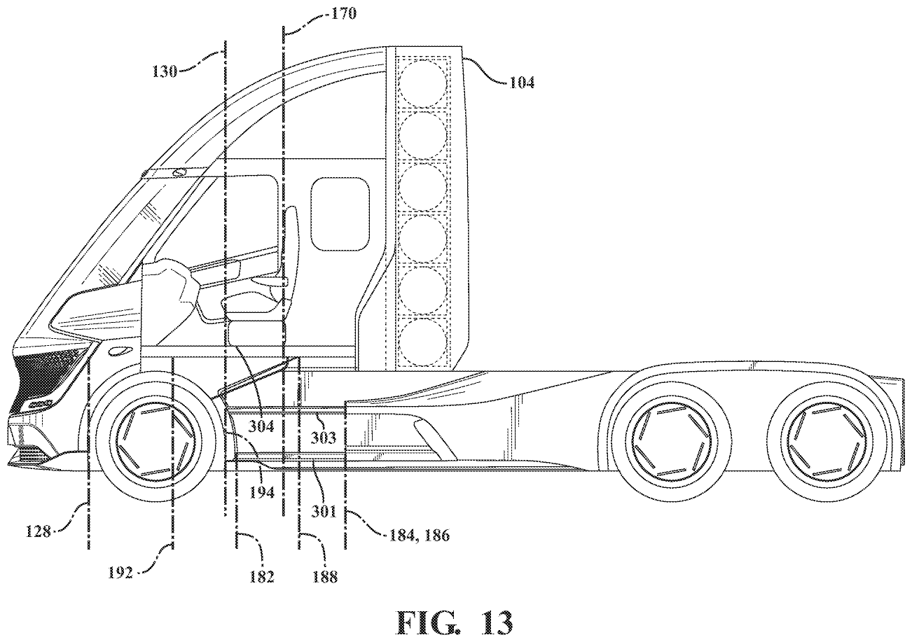

In certain embodiments, as shown in FIGS. 11-13, the first front entry step 301 may be arranged between the forward first front entry step axis 182 and the rearward first front entry step axis 184. The second front entry step 303 may be arranged between the forward second front entry step axis 194 and the rearward second front entry step axis 186. In some embodiments, shown in FIG. 13, the rearward first front entry step axis 184 and the rearward second front entry step axis 186 may be substantially the same. In particular embodiments, the rear wheel well axis 130 and the forward second front entry step axis 194 may be substantially the same, for example, as shown in FIG. 13. The third front entry step 304 may be arranged between the forward third front entry step axis 192 and the rearward third front entry step axis 188. Each of the forward first front entry step axis 182, the rearward first front entry step axis 184, the forward second front entry step axis 194, the rearward second front entry step axis 186, the forward third front entry step axis 192, and the rearward third front entry step axis 188 may be at different locations along the length of the main body 104.

In certain embodiments, the forward first front entry step axis 182 may be disposed rearward from the rear wheel well axis 130. A distance between the forward first front entry step axis 182 and the rearward first front entry step axis 184 may be about 958 mm. The first front entry step height 302 may be about 434 mm above the ground surface, and the first front entry step depth 305 being about 155 mm. Without being bound to any particular theory, it is believed that this particular arrangement of the plurality of steps may improve the ease of user to enter and exit from the cab, including climbing into and out from the cab 100.

In particular embodiments, also shown in FIGS. 11-13, the first front entry step 301 may be disposed adjacent a ground surface. The third front entry step 304 may be disposed adjacent to the bottom edge 154 of the doorway of the main body 104. The second front entry step 303 may be disposed between the first front entry step 301 and the second front entry step 303. The first front entry step 301 may be arranged between a forward first front entry step axis 182 and a rearward first front entry step axis 184. The second front entry step 303 may be arranged between the forward second front entry step axis 194 and the rearward second front entry step axis 186. The third front entry step may be arranged between the forward third front entry step axis 192 and the rearward third front entry step axis 188. In certain embodiments, each of the forward first front entry step axis 182, the rearward first front entry step axis 184, the forward second front entry step axis 194, the rearward second front entry step axis 186, the forward third front entry step axis 192, and the rearward third front entry step axis 188 may be at different locations along the length of the main body 104.

In certain embodiments, the forward second front entry step axis 194 may be disposed between the rear wheel well axis 130 and the forward first front entry step axis 182, and a distance between the forward second front entry step axis 194 and the rearward second front entry step axis 186 may be about 1020 mm. In certain embodiments, the second front entry step height 307 may be about 403 mm above the first front entry step, and the second front entry step depth 306 may be about 156 mm.

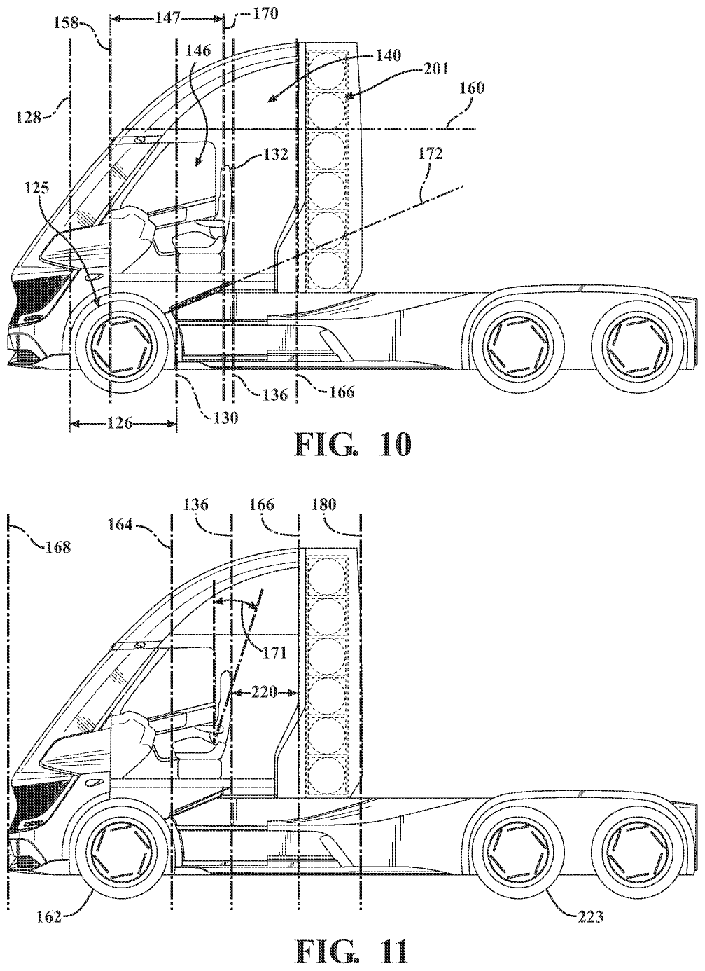

As described above, and as shown in FIGS. 10-14C, the cab 100 may include a first front entry step 301, a second front entry step 303 and a third front entry step 304. The first front entry step may be disposed adjacent a ground surface, the third front entry step 304 may be disposed adjacent the bottom edge 154 of the doorway 146 of the main body 104, and the second front entry step 303 may be disposed between the first front entry step 301 and the second front entry step 303.

The first front entry step 301 may be arranged between the forward first front entry step axis 182 and the rearward first front entry step axis 184, and the second front entry step 303 may be arranged between the forward second front entry step axis 194 and the rearward second front entry step axis 186, and the third front entry step 304 may be arranged between the forward third front entry step axis 192 and the rearward third front entry step axis 188, and each of the forward first front entry step axis 182, the rearward first front entry step axis 184, the forward second front entry step axis 194, the rearward second front entry step axis 186, the forward third front entry step axis 192, and the rearward third front entry step axis 188 may be at different locations along the length of the main body 104.

In certain embodiments, the forward third front entry step axis 192 may be disposed between the front wheel well axis 128 and the rear wheel well axis 130, and the rearward third front entry step axis 188 may be disposed between the rear wheel well axis 130 and the rear doorway axis 170, and a distance between the forward third front entry step axis 192 and the rearward third front entry step axis 188 may be about 873 mm.

As shown in FIGS. 14A-14C, in further embodiments the third front entry step height 308 may be about 441 mm above the second front entry step 303. The third front entry step 304 may be only accessible when the door 156 may be in the open position. In particular, the first front entry step 301 may be disposed adjacent a ground surface, the third front entry step 304 may be disposed adjacent the bottom edge 154 of the doorway 146 of the main body 104, and the second front entry step 303 may be disposed between the first front entry step 301 and the third front entry step 304. In certain embodiments, the forward third front entry step axis 192 may be disposed between the front wheel well axis 128 and the rear wheel well axis 130, and the rearward third front entry step axis 188 may be disposed between the rear wheel well axis 130 and the rear doorway axis 170, and a distance between the forward third front entry step axis 192 and the rearward third front entry step axis 188 may be about 873 mm. In certain embodiments, the third front entry step height 308 may be about 441 mm above the second front entry step 303. In still certain embodiments, the third front entry step 304 may be only accessible when the door 156 is in the opened position.

In certain embodiments, as shown in FIG. 6, the driver when seated may have an H-point of about 740 mm in an X direction, about −630 mm in a Y direction, and about 1210 mm in a Z direction. The seat 132 may have a rear seat clearance between about 260 mm and about 390 mm. In certain embodiments, the rear seat clearance may be about 327 mm. The seat may have a dorsal angle 171 of between about 14 degrees and about 20 degrees. In certain embodiments, the dorsal angle 171 may be equal to or less than about 17 degrees. In certain embodiments, the predetermined field of front vision for the windshield may be includes a front and upper vision 404 of about 28 degrees and a front and under vision 405 of about 17 degrees, relative to a horizontal forward line of sight axis 406 for the driver seated within the frontside volume of the main body. The H-point may be the hip point of the driver which may influence a height and a location of the driver's seat. In certain embodiments, by moving the H-point down in a Z-direction and forward in a X-direction, the driver may have a lower field of vision through the wrap around windshield 116, which in combination with a shape of the wrap around windshield 116 may improve a lower view of the driver out of the wrap around windshield 116 and decrease a size of a blind spot in front of the cab 100.

As shown in FIG. 6, in further embodiments a predetermined field of front vision 120 may include a blind spot 407 of at least 5716 mm in front of the cab 100. The predetermined field of front vision 120 may include a height of vision 401 of at least 9926 mm at a predetermined forward distance 409 of 12 meters. This illustrates an improved height of vision of the cab 100 in front of the vehicle as compared to a competitor height of vision 403 of 5000 mm at the predetermined forward distance 409, as has been shown in testing. The predetermined field of front vision 120 may also include a front and upper vision 404 of about 28 degrees and a front and under vision 405 of about 17 degrees. The predetermined field of front vision 120 may be appropriately influenced by a predetermined shield angle 124, for example, as shown in FIG. 5.

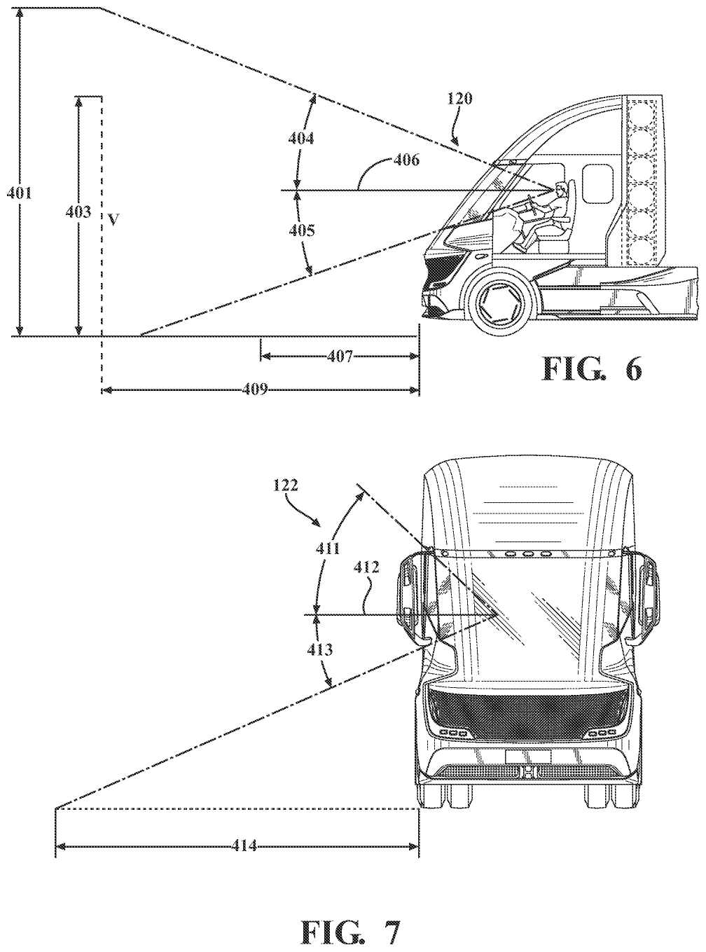

Now referring to FIG. 7, in certain embodiments, the predetermined field of side vision 122 may include a side and an upper vision 411 of about 43.6 degrees and a side and under vision 413 of about 26.1 degrees, relative to a horizontal side line of sight axis 412 for the driver seated within the frontside volume 142 of the main body 104. The predetermined of side vision 122 may also include a blind spot 414 of about 4142 mm.

In certain embodiments, a predetermined shield angle of A-pillar may be between about 6 degrees and about 7 degrees. For example, the predetermined shield angle of A-pillar may be about 6.3 degrees. The front entry steps may include a first front entry step, a second front entry step, and a third front entry step.

As further shown in FIGS. 15-17, in certain embodiments, the cab 100 may further include a plurality of fuel tanks 201. In certain embodiments, the plurality of fuel tanks 201 may be disposed entirely within the cab 100 of main body 104 such as shown in FIGS. 11-13. In certain embodiments, a second set of fuel tanks 203 may be disposed adjacent to a fuel cell power plant 226 of the semi-truck vehicle. The plurality of fuel tanks 201 may be supported by a vertically disposed frame 205 in a vertical arrangement. The plurality of fuel tanks 201 may include hydrogen fuel tanks.

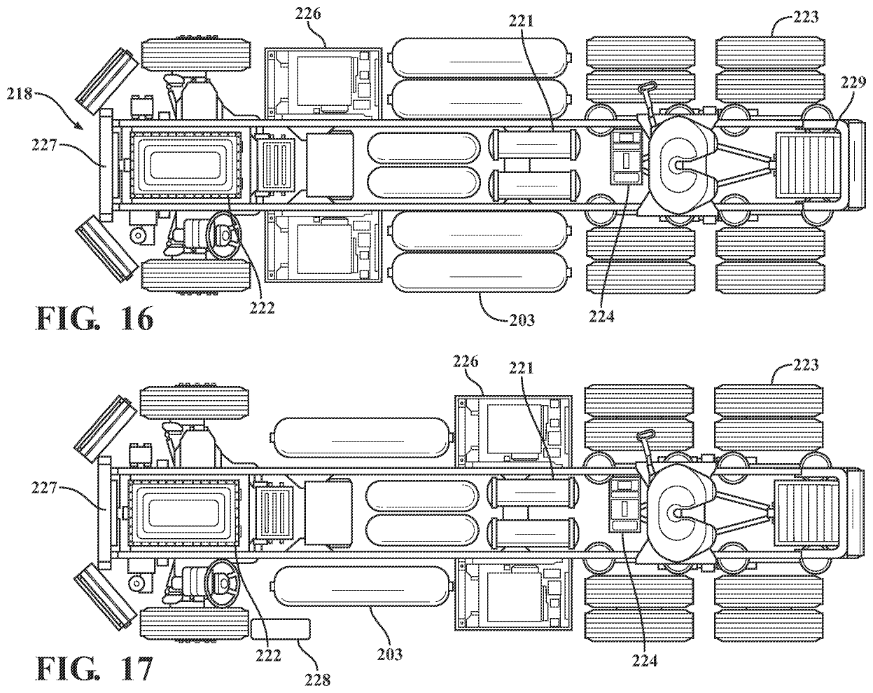

In addition, for example, as shown in FIGS. 16-17, components such as a battery 222, the second set of fuel tanks 203, a motor 224, brakes 221, a fuel cell power plant 226, a battery 229, and a radiator assembly 227 may be supported by a vehicle chassis or frame 218. In certain embodiments, the various components supported by the frame 218 are configured to accommodate the other components of the cab 100, such as a step location 228. It should be appreciated that the step location 228 may be laterally spaced apart from the second set of fuel tanks, as shown in FIG. 17. It is envisioned that the frame 218 may support more or less components of the cab 100 as appropriately desired. For example, in certain embodiments, the cab 100 may include an electronic control unit (ECU) and/or an electronic control module (ECM) for controlling an electrical system of the cab 100. In certain embodiments, a rear suspension may include an airbag suspension system. However, the rear suspension may include another suspension system as appropriately desired for supporting the cab 100 including one or more rear wheels 223.

### EXAMPLES

The tables below include test data of the cab 100 according to the present disclosure in comparison to certain competitors, and which illustrates an improved field of vision of the cab 100 at a blind area in front of the vehicle (Table 1) and at a side vision area of the vehicle (Table 2).

TABLE 1

| | Front and | Front and | Blind Spot In | Height of |
|---|---|---|---|---|
| | Upper | Under | Front of | Vision |
| | Vision | Vision | Vehicle | at 12 Meters |
| CAB 100 | 28.2° | 17° | 5716.8 mm | 9926.3 mm |
| Competitor 1 | 11.5° | 18° | 6700 mm | 5000 mm |
| Competitor 2 | 17.2° | 14.3° | 6754.3 mm | 6907.1 mm |

TABLE 2

| | Side and Upper | Side and Under | |
|---|---|---|---|
| | Vision | Vision | Blind Area |
| CAB 100 | 43.6° | 26.1° | 4142.3 mm |
| Competitor 1 | 18° | 42° | |

Advantageously, the present technology provides improved sight lines, improved ride quality, and an easy ingress into and egress from a cab of the semi-truck, especially as compared to the Competitor 1 and Competitor 2 detailed in the Tables 1 and 2, above. Additionally, a position of the seat 132 within the interior of the cab 100 and the front wrap around windshield 116 is believed to improve the sightlines of an occupant within the cab 100. Additionally, the relative locations and dimensions of the front entry steps 300 and a position of the door 156 and the doorway 146 are believed to facilitate an ease in entering and exiting of the cab 100 and access by the occupant to and from the seat 132.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In certain example embodiments, well-known processes, well-known device structures, and well-known technologies are not described in detail. Equivalent changes, modifications and variations of certain embodiments, materials, compositions and methods can be made within the scope of the present technology, with substantially similar results.

What is claimed is:

1. A cab for a semi-truck vehicle, comprising:
a main body having a forward side, a rearward side, a first side, a second side, a length, a wrap around windshield, and a wheel well, the forward side and the rearward side located at opposed ends of a length of the main body, the wrap around windshield disposed across an entirety of the forward side and across only part of the first side and the second side, the wrap around windshield having a rear end on each of the first side and the second side, the wrap around windshield further having a predetermined field of front vision, a predetermined field of side vision, and a predetermined shield angle of A-pillar, and the wheel well having a front portion and a rear portion;
a seat disposed within the main body and having a frontside and a rearside;
a rear wall disposed within the main body and behind the rearside of the seat, the rear wall spaced apart from the rearward side of the main body;
a cabin interior configured to accommodate a driver, the cabin interior located within the main body between the wrap around windshield and the rear wall, the seat disposed within the cabin interior, and the cabin interior including a frontside volume and a rearside volume, the frontside volume disposed between the seat and the wrap around windshield, and the rearside volume disposed between the seat and the rear wall;
a doorway formed in the main body, the doorway having a front edge, a rear edge, a top edge, and a bottom edge, and the doorway providing ingress and egress to the cabin interior;
a plurality of front entry steps disposed beneath the doorway and adjacent the rear portion of the wheel well; and
a door configured for selectively opening the doorway where in an opened position and selectively closing the doorway where in a closed position, the door disposed adjacent the front portion of the wheel well of the main body and permitting ingress and egress directly to the frontside volume of the cabin interior by the driver using the plurality of front entry steps upon the door being in the opened position, and at least a portion of the seat disposed rearward of the rear edge of the doorway,
wherein the front edge of the doorway is disposed on a front doorway axis, and the rear edge of the doorway is disposed on a rear doorway axis, and the top edge of the doorway is disposed on a top doorway axis, and the bottom edge of the doorway is disposed on a bottom doorway axis, and the front portion of the wheel well is disposed on a front wheel well axis, and the rear portion of the wheel well is disposed on a rear wheel well axis, and the frontside of the seat is disposed on a frontside seat axis, and the rearside of the seat is disposed on a rearside seat axis, and the rear wall is disposed on a rear wall axis, the rearside seat axis located forward of the rear wall axis a predetermined distance, and the rear end of the wrap around windshield disposed on a rear end window axis, the forward side of the main body is disposed on a forward side axis, and the rearward side of the main body is disposed on a rearward side axis.

2. The cab of claim 1, wherein the plurality of front entry steps include a first front entry step, a second front entry step, and a third front entry step, the first front entry step disposed adjacent a ground surface, the third front entry step disposed adjacent the bottom edge of the doorway of the main body, and the second front entry step disposed between the first front entry step and the second front entry step, and the first front entry step is arranged between a forward first front entry step axis and a rearward first front entry step axis, and the second front entry step is arranged between a forward second front entry step axis and a rearward second front entry step axis, and the third front entry step is arranged between a forward third front entry step axis and a rearward third front entry step axis, and each of the forward first front entry step axis, the rearward first front entry step axis, the forward second front entry step axis, the rearward second front entry step axis, the forward third front entry step axis, and the rearward third front entry step axis are at different locations along the length of the main body.

3. The cab of claim 2, wherein the forward second front entry step axis is disposed between the rear wheel well axis and the forward first front entry step axis.

4. The cab of claim 3, further comprising a first hand hold disposed adjacent the front edge of the doorway and a second hand hold disposed adjacent the rear edge of the doorway, and the first hand hold and the second hand hold being configured to be grabbed simultaneously by the driver while standing on the first front entry step and the second front entry step during ingress and egress to the cabin interior.

5. The cab of claim 4, wherein the third front entry step is accessible when the door is in the opened position.

6. The cab of claim 1, further comprising a plurality of fuel tanks for the semi-truck vehicle.

7. The cab of claim 6, wherein the plurality of fuel tanks are hydrogen tanks.

8. The cab of claim 7, further comprising a rack disposed been the rear wall axis and the rearward side axis, and the plurality of fuel tanks are supported by the rack in a vertical arrangement.

9. The cab of claim 8, wherein the plurality of fuel tanks are disposed entirely within the main body of the cab.

10. The cab of claim 9, wherein the plurality of fuel tanks includes a first set of fuel tanks and a second set of fuel tanks, and the first set of fuel tanks are disposed entirely within the main body of the cab and supported by the rack, and the second set of fuel tanks are disposed outside of the main body of the cab and are not supported by the rack.

11. The cab of claim 10, wherein the second set of fuel tanks are disposed at least partly underneath the main body.

12. The cab of claim 11, wherein the second set of fuel tanks are disposed adjacent to the plurality of front entry steps of the main body.

13. The cab of claim 1, wherein the rearside seat axis is disposed between the rear doorway axis and the rear wall axis.

14. The cab of claim 1, wherein the bottom doorway axis is oriented at a bottom edge angle relative to a horizontal axis, whereby the bottom edge slopes in an upward direction away from the rear portion of the wheel well of the main body.

15. The cab of claim 1, wherein there is no other door disposed rearward of the door of the main body.

16. The cab of claim 1, wherein the rear end window axis is disposed rearward of the rear doorway axis.

17. The cab of claim 1, further comprising a grille, wherein a top grill section is oriented on a top grill section axis and a bottom grill section is oriented on a bottom grill section axis, and the top grill section axis and the bottom grill section axis intersecting to define a concave area angle.

18. The cab of claim 17, wherein the wrap around windshield narrows inwardly at a location above the grille.

19. The cab of claim 1, further comprising a first headlamp and a second headlamp, the first headlamp disposed adjacent the first side of the main body, and the second headlamp disposed adjacent the second side of the main body, a grille disposed between the first headlamp and the second headlamp.

20. The cab of claim 19, wherein each of the first headlamp and the second headlamp include a plurality of headlamp elements.
